(19) United States
(12) Patent Application Publication
(10) Pub. No.: US 2016/0321586 A1
(43) Pub. Date: Nov. 3, 2016

(54) SELECTING TESTS FOR EXECUTION ON A SOFTWARE PRODUCT

(71) Applicant: Microsoft Technology Licensing, LLC, Redmond, WA (US)

(72) Inventors: Kim Herzig, Cambridge (GB); Jacek Czerwonka, Sammamish, WA (US); Brendan Murphy, Cambridgeshire (GB); Michaela Greiler, Villach (AT)

(21) Appl. No.: 14/699,387

(22) Filed: Apr. 29, 2015

(51) Int. Cl. G06Q 10/06; G06F 11/36

(52) U.S. Cl. CPC G06Q 10/06313; G06F 11/3684; G06F 11/3692

(57) ABSTRACT

A method of automatically selecting tests for execution on a software product includes generating a cost model based on test performance history data that is based on results of past executions of a plurality of tests on the software product, wherein the cost model provides, for each test in the plurality of tests, a first expected monetary cost value associated with executing the test and a second expected monetary cost value associated with skipping execution of the test. The method includes automatically selecting tests in the plurality of tests for future execution based on the first and second expected monetary cost values.

### BACKGROUND

Software testing is an element of software development processes. A purpose of testing is to ensure that code changes applied to a software product do not compromise product quality. Often, testing is associated with checking for functional correctness. However, for large complex software systems, it also typically involves verifying system constraints, such as backward compatibility, performance, security, etc.

### SUMMARY

Some embodiments are directed to a system and method for performing a test optimization that is based on predicted test cost and test benefit of future test executions based on historical patterns. Past test execution events (test runs) are given a context, for example, the language and architecture that was tested, code changes testing was targeting, the branch from which the build was taken, etc. The result of such a test is then categorized into a success (test passed) or a test failure. Test failures are further subdivided into a product-related failure (true positive) or a failure due to tests or infrastructure (false positive). These data points provide enough information for both the test cost and test benefit to be converted into a common unit, which is expressed as a monetary cost value. Future test pass executions are informed by the predicted test cost and test benefit, and if the cost exceeds the benefit for a given test, the system does not select the test for execution. The test selection output may be used to decide which tests to skip or execute, or also to prioritize test executions based on their costs.

One embodiment is directed to a method of automatically selecting tests for execution on a software product. The method includes generating a cost model based on test performance history data that is based on results of past executions of a plurality of tests on the software product, wherein the cost model provides, for each test in the plurality of tests, a first expected monetary cost value associated with executing the test and a second expected monetary cost value associated with skipping execution of the test. The method includes automatically selecting tests in the plurality of tests for future execution based on the first and second expected monetary cost values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a diagram illustrating a computing environment suitable for implementing aspects of a code test selection system according to one embodiment.

FIG. 2 is a block diagram illustrating modules of code test selection system according to one embodiment.

FIG. 3 is a flow diagram illustrating a test execution simulation process according to one embodiment including the evaluation of the model performance.

FIG. 4 is a diagram illustrating a result table identifying tests executed during the simulation shown in FIG. 3.

FIG. 5 is a diagram illustrating activities on development branches of an example software product according to one embodiment.

FIG. 6 is a diagram illustrating a potential path of a code bug between four code branches.

FIG. 7 is a flow diagram illustrating a method of automatically selecting tests for execution on a software product according to one embodiment.

### DETAILED DESCRIPTION

In the following Detailed Description, reference is made to the accompanying drawings, which form a part hereof, and in which is shown by way of illustration specific embodiments in which the disclosure may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

It is to be understood that features of the various exemplary embodiments described herein may be combined with each other, unless specifically noted otherwise.

The process for developing large software products is predominantly through developing a single component across multiple code branches, or through developing independent components that form the product. In developing code across multiple code branches, a “code branch” is a forked version of the code base that allows parallel modifications without interference. An alternative is to architect the product into multiple independent components. Each component can be developed independently on a single code branch.

Complex software systems are developed by thousands of engineers that simultaneously apply code changes, which may interfere with each other. In such environments, testing may be seen as an insurance process verifying that the software product complies with all system constraints at all times. By nature, system and compliance tests are complex and time-consuming, although they rarely find a defect. Large complex software products tend to run on millions of configurations in the field and emulating these configurations involves multiple test infrastructures and procedures that are expensive to run in terms of cost and time. Making tests faster is desirable but usually involves enormous development efforts. Simply removing tests increases the risk of expensive bugs being shipped as part of the final product, or at least delays the detection of the bug, which also leads to higher debugging and fixing costs. This is a generic issue for developing large complex software systems. At the same time, long running test processes increasingly conflict with the need for software companies to deliver software products in shorter periods of time while maintaining or increasing product quality and reliability. Increasing productivity through running a lesser number of tests is desirable but threatens product quality, as code defects may remain undetected.

Testing is an expensive process both in terms of a machine and human cost as well as time it takes, especially for system and integration tests. The cost and time delay problem is exacerbated on large projects and engineering teams often attempt to optimize it. For such optimization to be successful (i.e., to provide execution cost savings without affecting quality), a question to answer is which tests can safely be selected for execution or conversely eliminated from execution.

Manual test selection (e.g., one based on the experience of engineers) is possible and often employed, but is of limited effectiveness, especially on projects with millions of lines of code and thousands of tests, where understanding of all interactions between product components and the product and tests are complex and changing over time. Such a manual effort is also static. Thus, a test is either classified as effective or not, but the test's effectiveness may depend on the dynamic execution context, which is not considered when making human (offline) decisions.

Traditional automated solutions to this problem rely on selecting tests based on code coverage. Code coverage provides data to associate tests with fragments of source code. When source code changes, tests associated with the changed fragments are selected for execution. This scheme has disadvantages, including the following.

(1) The code coverage data is often difficult to collect and maintain. It might need a separate test pass just to collect the data. It can be especially expensive if the codebase is large or tests take a long time to execute.

(2) If the changed code fragment is core to the functionality, it is likely that many tests (with redundant coverage) will be selected for execution.

(3) The fact that a test covers (executes) a statement does not imply that the result (returned value or side effects) are checked for correctness, except for runtime failures.

One embodiment is directed to a method of performing test optimization that does not depend on availability of code coverage data. Rather, the method selects and eliminates tests based on the prior history of test execution. Unlike code coverage, which often involves special infrastructure and treatment, this data is collected as a direct by-product of testing. It is therefore less costly, simpler to maintain, and does not introduce extra process delays or cost factors.

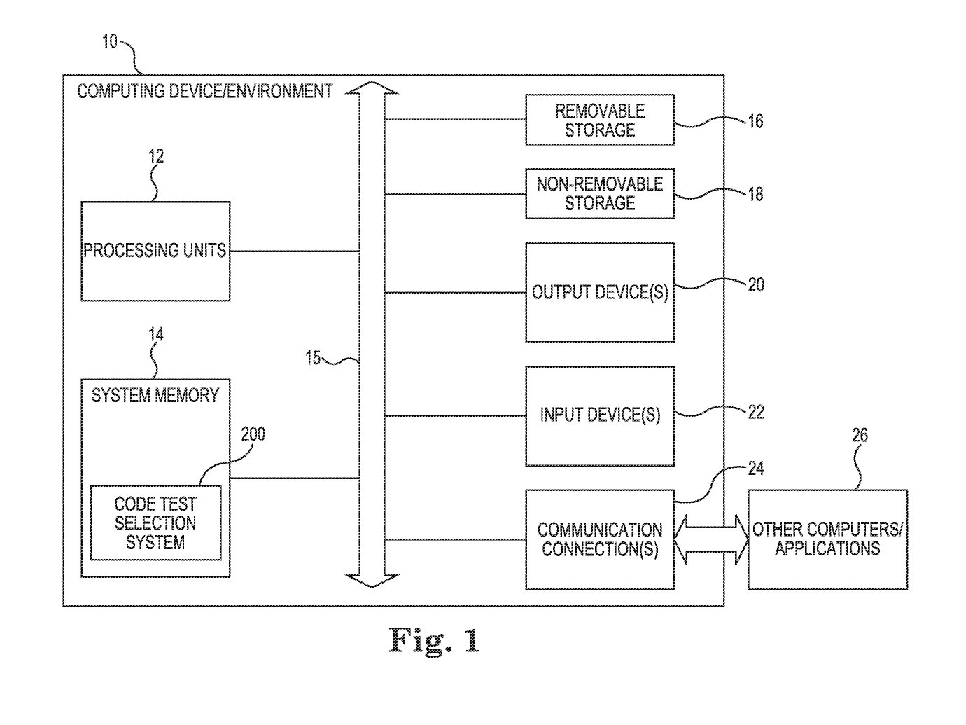

FIG. 1 is a diagram illustrating a computing environment 10 suitable for implementing aspects of a code test selection system according to one embodiment. In the illustrated example, the computing system or computing device 10 includes one or more processing units 12 and system memory 14. Depending on the exact configuration and type of computing device, memory 14 may be volatile (such as RAM), non-volatile (such as ROM), or some combination of the two.

Computing device 10 may also have additional or different features/functionality and additional or different hardware and software. For example, computing device 10 may also include additional storage (removable and/or non-removable) including, but not limited to, magnetic or optical disks or tape. Such additional storage is illustrated in FIG. 1 by removable storage 16 and non-removable storage 18. Computer storage media includes volatile and nonvolatile, removable and non-removable media implemented in any suitable method or technology for storage of information such as computer readable instructions, data structures, program modules or other data. Memory 14, removable storage 16 and non-removable storage 18 are all examples of computer storage media (e.g., non-transitory computer-readable storage media storing computer-executable instructions that when executed by at least one processor cause the at least one processor to perform a method). Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices. Any such computer storage media may be part of computing device 10. Non-transitory computer-readable storage media as used herein does not include transitory propagating signals.

The various elements of computing device 10 are communicatively coupled together via one or more communication links 15. Computing device 10 also includes one or more communication connections 24, such as network connections, that allow computing device 10 to communicate with other computers/applications 26. Computing device 10 may also include input device(s) 22, such as keyboard, pointing device (e.g., mouse), pen, voice input device, touch input device, etc. Computing device 10 may also include output device(s) 20, such as a display, speakers, printer, etc.

FIG. 1 and the above discussion are intended to provide a brief general description of a suitable computing environment in which one or more examples may be implemented. It should be understood, however, that handheld, portable, and other computing devices of all kinds are contemplated for use. FIG. 1 thus illustrates an example of a suitable computing system environment 10 in which the examples described herein may be implemented, although as made clear above, the computing system environment 10 is one example of a suitable computing environment and is not intended to suggest any limitation as to the scope of use or functionality of the examples. Neither should the computing environment 10 be interpreted as having any dependency or requirement relating to any one or combination of components illustrated in the example operating environment 10.

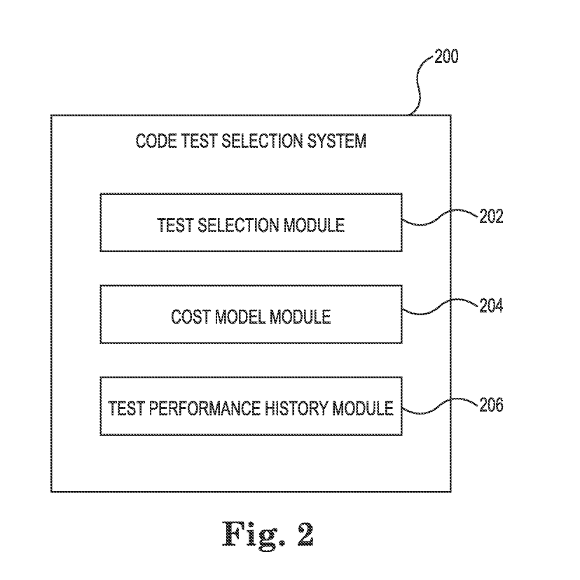

As shown in FIG. 1, a code test selection system 200 is stored in system memory 14. One example of system 200 selects and eliminates tests based on a cost model and the prior history of test execution. System 200 is described in further detail below with reference to FIG. 2.

FIG. 2 is a block diagram illustrating modules of code test selection system 200 according to one embodiment. System 200 includes a test selection module 202, a cost model module 204, and a test performance history module 206. In one embodiment of system 200, test selection module 202 selects and eliminates tests using cost model module 204 and test performance history module 206. It is noted that the functionality of the modules in system 200 can be combined into a single module, or can be combined or broken apart in any other desired manner. Each module in system 200 according to one example is a combination of hardware and software executing on that hardware to provide a given functionality.

In one embodiment, system 200 performs a test optimization method that is based on predicted test cost and test benefit of future executions based on historical patterns. Past test execution events (test runs) are given a context, for example, the language and architecture that was tested, code changes testing was targeting, the branch from which the build was taken, etc. The result of such a test is then categorized into a success (test passed) or a test failure. Test failures are further subdivided into a product-related failure (true positive) or a failure due to tests or infrastructure (false positive). This past test data is represented by test performance history module 206. These data points provide enough information for both the test cost and test benefit to be converted into a common unit, which is expressed as a monetary cost value. The cost information is represented by cost model 204.

Future test pass executions are informed by the predicted test cost and test benefit, and if the cost exceeds the benefit for a given test, test selection module 202 does not select the test for execution. System 200 is a self-adapting system that avoids unnecessary cost while maintaining the level of bug detection of the test process.

In one embodiment, the decision by test selection module 202 whether to execute a test for a given execution context is based solely on monetary cost (i.e., the monetary cost associated with executing and not executing the test). One embodiment of system 200 uses a cost model 204 that is sensitive to performance history of a test as it considers past executions to assess the expected cost values. For each decision, two different scenarios are considered: executing the scheduled test and not executing it. Expected costs are estimated for both scenarios, and the scenario with the lower expected cost is selected. Thus, if the estimated cost of not executing the test (Cₛₖᵢₚ) is lower than the cost of executing the test (C_{exec}), the test execution is skipped.

For both execution scenarios, the contributing cost factors are considered. Executing a test not only raises computational cost but also the cost of test result inspection or triaging. Executing tests that often report false positives can trigger unnecessary failure inspection performed by engineers. On the other hand, not executing a test might lead to undetected code issues that will escape later parts of the lifecycle and therefore impact more engineers or even customers. In this disclosure, cost factors that are described with positive values express the expected cost to be paid.

Test performance history module 206 collects the results of prior test executions. The main data collection categories according to one embodiment are: (1) general test execution information; (2) test runtime information; (3) test results information; and (4) execution context information. Each of these categories is discussed in further detail below.

For the general test execution information category, the unique name of the executed test (TestName) and the unique identifier of the test execution instance (TestExecID) are collected by module 206. This data allows the system 200 to bind and group test execution results to the according test case.

For the test runtime information category, the module 206 collects the time (e.g., total number of seconds) taken for the test to run, i.e., the test execution time (TestExecDuration) for each test execution as recorded by the test framework.

For the test results information category, the module 206 collects the results of all tests being run within the development process. Possible values of the test execution result (TestExecResult) include passed, defect, false alarm, and undecided. A test failure is where the expected result of a test could not be produced (i.e., assertion failed), or the whole test execution terminated with an error. Usually, it is assumed that a failing test indicates a code defect, caused by introducing a defect (e.g., through side effects) when merging multiple parallel-developed code changes. However, it might also be that the test case reporting the test failure is not reliable. Test failures due to test reliability issues are referred to as false alarms. Categorizing a test result as passing or failing is implicitly given by the testing framework. Test failures are also further distinguished into code defects and false alarms. Using links between test failures and bug reports, the system 200 can distinguish test failures due to code defects from false alarms. If the failure led to a bug report that was later fixed by applying a code change, it is marked as a true code defect. Otherwise, the failed test execution is marked as a false alarm. To identify their cause, test failures are manually inspected to either fix the problem or identify the test failure as a false alarm. Due to resource restrictions, not all test failures may be investigated. Therefore, test failures that were not manually investigated are marked as undecided and ignored, as their cause is indeterminable.

With respect to the execution context information category, modern software systems tend to be multi-platform applications running on different processor architectures, different machines, and different configurations. An execution context is defined as a set of properties used to distinguish between different test environments. One embodiment uses the execution context properties BuildType, Architecture, Language, and Branch. Possible values of BuildType according to one embodiment include debug and release. Possible values of Architecture according to one embodiment include x86, x64, and arm. Language identifies the language of the binaries under test (e.g., en-us), and Branch is a unique identifier of the source code branch on which the test execution was performed. However, the concept of execution contexts is variable. An example would be to use the kind of code change or the location of the code change as another aspect of an execution context. Adding or removing properties influences the number of different execution contexts but does not involve a modification of the general approach. A test may show different execution behaviors for different execution contexts. For example, a test might find more issues on code of one branch than another depending on the type of changes performed on that branch. For example, test cases testing core functionality might find more defects on a branch containing kernel changes than on a branch managing user interface changes. Thus, system 200 not only differentiates between test cases, but also binds historic defect detection capabilities of a test to its execution context.

Cost model 204 for test executions is based on historic test execution results that causes no test execution runtime overhead, and is capable of readjusting its cost estimations based on execution contexts (e.g., configurations of the test environment). Cost model 204 takes into account several cost factors, including a base cost of test execution, cost of a false positive task failure, cost of bugs escaping a set of tests, and failure probabilities. Each of these factors is discussed in further detail below.

Base Cost of Test Execution

One factor that is considered when assessing the cost to run a test is the time-shared cost of infrastructure to execute a test on all execution contexts. The value, C_{machine}, is a constant representing the per minute infrastructure cost. Multiplied with the execution time per test results in the total infrastructure cost of running a test. For the Microsoft development environment, for example, C_{machine} has been computed to have a value of 0.03 $/min. The cost factor corresponds roughly to the cost of a memory intense Azure Windows virtual machine and includes power and hardware consumption, as well as maintenance costs. For example, assume that the total number of executions of test A in a given execution context is 100 and that each execution takes 10 minutes. Thus, the total machine cost to run test A in that context accumulates to 100*10*0.03 $/min=$30.

Cost of a False Positive Task Failure

All test failures involve human inspection effort, but inspecting failing tests due to anything other than code defects should be avoided. The cost of a test inspection equals the amount of time for manual inspection times the salary of the engineers conducting the inspections. The cost constant, C_{inspect}, represents the average cost rate of inspecting a test failure. As an example from Windows, considering the size of the test failure inspection teams, the number of inspections performed and the average salary of engineers on that team, the average cost per inspection instance has been computed to be $9.60. This cost may vary from case to case, but the reported cost factor corresponds to the average cost of a test inspection and reflects the time spent by inspecting engineers. Additional cost factors such as waiting time for engineers or the need to run extra tests is not included, although the formula can be updated to account for these as well.

Cost of Escaped Defects

Code defects escaping a test run can be expensive. The longer a defect remains hidden the more people can potentially be affected and the more expensive the escaped defect becomes. Defects closer to release dates tend to be more expensive, and increased time from defect introduction to its detection increases cost because root cause analysis is aggravated (more changes have been applied since then). Understanding and fixing an older change is more difficult. Additionally, the greater the number of engineers that are exposed to the defects, the longer disruptions will be while searching and fixing the defects. Defects usually imply some sort of development freeze, e.g., no new check-ins allowed until issue resolved.

The constant, C_{escaped}, represents the average cost of an escaped defect. This cost depends on the number of people that will be affected by the escaped defect and the time duration the defect remains undetected. One embodiment uses a value of $4.20 per developer and hour of delay for C_{escaped}. This value represents the average cost of a bug escaping within Microsoft. Depending on the time the defect remains undetected and the number of additional engineers affected, a defect escaping from a development branch into the main trunk branch in Windows can cost tens of thousands of dollars.

Failure Probabilities

Cost model 204 use the expected cost of a task execution as a measurement. Unlike some other cost models, the expected cost is not based on constants explaining the average testing behavior, but is based on historic performance records (i.e., test performance history 206). This allows precise cost estimations to be uniquely derived for a specific test and its execution context history: branch, architecture, build type, and number of previous reported true positives and false positives. A test may show different execution behaviors for different execution contexts. For example, tests executed on branches where complex code changes take place (e.g., Windows kernel) may find more issues compared to executions of the same test performed on branches with low complexity changes (e.g., applications). Thus, the cost model 204 not only differentiates between tests, but also binds the cost estimations of a test to its execution context.

Given a planned test execution and given the corresponding execution context, the cost model 204 consults test performance history 206 to determine the history of task executions of the same test in the same execution context and derives the number of true reported defects and the number of false alarms that the test reported. From these past observations, two failure probabilities can be derived: P_{TP} is the probability that a given combination of test and execution context will detect a defect (true positive) and is given in the following Equation I, and P_{FP} is the false failure probability that a given combination of test and execution context will report a false alarm (false positive) and is given in the following Equation II.

$$\begin{matrix}{P}_{TP} ( t , c ) = \frac{\# detected defects ( t , c )}{\# executions ( t , c )} & Equation I \\ {P}_{FP} ( t , c ) = \frac{\# false alarms ( t , c )}{\# executions ( t , c )} & Equation II\end{matrix}$$

In Equations I and II, the tuple (t, c) is a combination of test t and execution context c, where #detected defects (t, c) represents the number of defects reported by t when executed in c; #executions (t, c) represents the number of times t has been executed in c, and where #false alarms (t, c) represents the number of false test alarms caused by t when executed in c. For example, consider a test t executed 100 times in an execution context c, e.g., on build type release, architecture x64, branch b, and language en-us, which reported 4 false alarms and 7 defects, then P_{FP} (t, c)=0.04 and P_{TP} (t, c)=0.07.

Cost Functions

The individual cost components are combined into two cost functions: the expected cost of executing the test, C_{exec}, and the expected cost of not executing the test, Cₛₖᵢₚ. C_{exec} represents the expected cost if it is decided to execute the test and depends on the machine cost (C_{machine}), the probability that the executed test will fail due to any other reason as a defect (P_{FP}), and the cost of conducting an unnecessary test failure inspection (C_{inspect}):

C_{exec}=C_{machine}+(P_{FP}*C_{inspect}) Equation III

Similarly, Cₛₖᵢₚ represents the expected cost of not executing the test, which depends on the cost of elapsed defects (C_{escaped}) and the number of additionally affected engineers (#Engineers) and the time the defect remains undetected (Time_{delay}):

Cₛₖᵢₚ=P_{TP}*C_{escaped}*Time_{delay}*#Engineers Equation IV

The additional number of engineers affected comes from the fact that if a test is skipped that would have found a bug, the bug will potentially propagate to higher level branches and thus will impact more engineers from other parallel branches that will have to merge their changes through the branch that was just infected with a bug. Or, in the case of a single branch but multiple component product, more people (over time on that branch) will work on a code base that is defective and thus encounter test issues.

For tests that found no defects in the given execution context, P_{TP} and Cₛₖᵢₚ is zero and the test is skipped. The same test for a different execution context (e.g., different branch) is likely to have a different P_{TP} value and thus might remain enabled.

Test Selection Based on Cost Model

For every planned test execution, the cost model 204 supplies to test selection module 202 the cost of executing and the cost of skipping the planned test execution, providing its execution context (e.g., branch, architecture, and build type). Test selection module 202 skips all task executions for which the expected cost to execute the planned task exceeds the expected cost of skipping the planned task: C_{exec}>Cₛₖᵢₚ.

In one embodiment, test selection module 202 either decides to run the originally planned test execution in the given context or vetoes the execution and removes the planned test execution from the schedule. In one embodiment, test selection module 202 does not influence which test gets scheduled nor does it change the execution context of a test.

Based on up-to-date historic test execution data in test performance history 206, each decision made by test selection module 202 has an impact on the cost model 204. The cost model 204 according to one embodiment treats each test executed in these builds as unique, but dependent decision points are influenced by three main factors: failure probabilities, cost constants, and code changes. All decision points are connected through their failure probabilities (P_{TP} and P_{FP}). System 200 is self-adapting as it dynamically changes cost considerations based on earlier decisions.

In one embodiment, test selection module 202 skips more test executions in execution contexts where they have a low probability of finding code issues and skips fewer task executions in contexts with a high probability of finding code issues. Consequently, the development process velocity will remain unchanged for failure prone contexts while it accelerates for contexts with low true positive probabilities—fewer tests will be executed. If all engineers produce the same level of quality, system 200 stabilizes its decisions and the level of testing for individual contexts correlates with the level of code change difficulty.

Simulating Test Case Executions

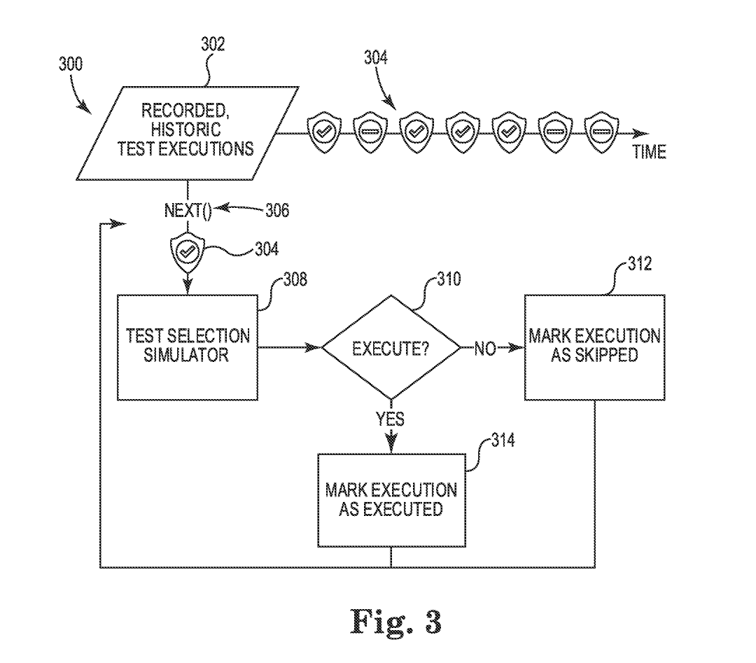

FIG. 3 is a flow diagram illustrating a test execution simulation process 300 according to one embodiment. As shown in FIG. 3, the process 300 uses recorded, historic test executions 302, which correspond to test performance history 206 in FIG. 2, and uses test selection simulator 308, which corresponds to test selection module 202 in FIG. 2. For each test execution and its execution context, ordered by time stamp, simulator 308 decides which tests should have been executed and which tests should have been skipped.

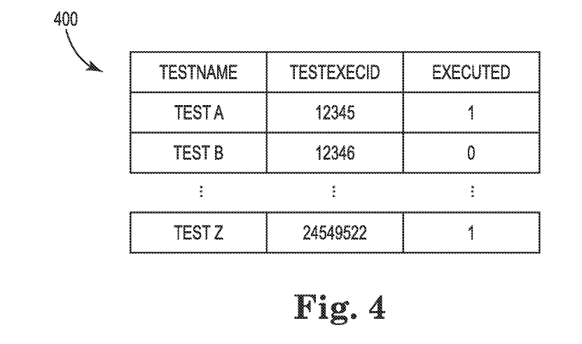

FIG. 4 is a diagram illustrating a result table 400 identifying tests executed during the simulation shown in FIG. 3. The first column of table 400 includes the name (TestName) of each test execution. The second column of table 400 includes a unique identifier (TestExecID) for each test execution. The third column of table 400 includes an indication of whether the test execution was selected by the simulator 308 for execution. Tests that would have been skipped by simulator 308 contain a 0 in the third column, and tests that would have been selected for execution by simulator 308 contain a 1.

To simulate the behavior and impact of system 200, test executions as they occurred in past development periods were replayed by simulation process 300. Test executions and their test results (failed or passed) are recorded in databases by the test execution framework. Using these databases, the test suite and test case executions, the execution contexts in which these tests were executed, and the order in which these tests run, are all known. This information is sufficient for the simulation shown in FIG. 3.

Using the databases containing the test executions and their corresponding test execution results (failed or passed), these historic test executions 304 are ordered by their execution timestamp, and are shown in FIG. 3 along a horizontal line representing time. For historic test executions 304, a checkmark indicates a test that passed, and a minus sign indicates a test that failed. Simulator 308 is fed with test executions 304 in the order they were applied.

Each historic test execution 304 including its corresponding test execution context definition is fed into simulator 308. At 310, the simulator 308 decides whether the current test execution 304 should be executed. The simulator 308 then returns a binary decision indicating whether the test case received as input is selected to be executed. Depending on the binary result, the originally executed test is marked in table 400 as skipped (i.e., binary 0) at 312, or is marked as executed (i.e., binary 1) at 314. Skipped test executions represent those test executions that would not be selected by system 200 for execution. The process 300 then returns to 306 (i.e., Next( ), to retrieve and process the next test execution 304.

The simulation process shown in FIG. 3 does not execute test cases. It makes decisions on whether a test case would have been executed, depending on the cost balance influenced by the test's defect finding capabilities. The result of this test case simulation is a table 400 of test case executions that would have been prevented when using system 200. This table 400 can be used to compare against the original set of executed tests.

Removing test executions may impact code quality. Defects detected by test executions that have been removed by system 200 would remain undetected, at least for some time. Disabling test executions is likely to have an impact on code changes and developer behavior, which cannot be simulated. Thus, an estimation was also made regarding how undetected defects would propagate through the development process and when they would be detected.

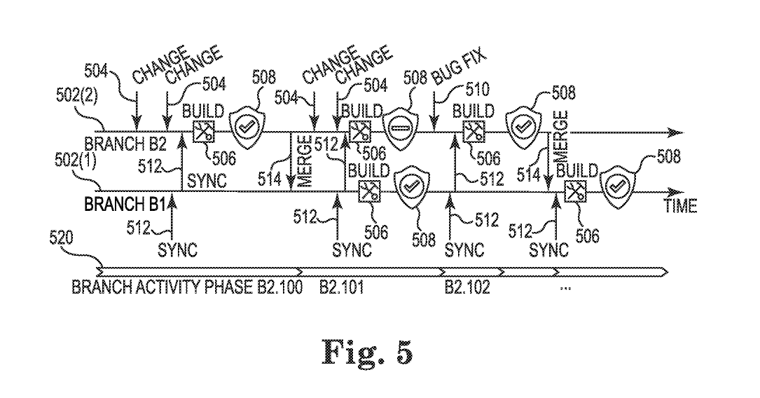

The heuristic estimating when and where escaped defects would have been recaptured involves more data about the actual project specific development process. This data provides further insights in how code changes and how defects propagate through the development process. For this part of the simulation, project specific datasets were collected, and some assumptions were made about code issues and test behavior. Before describing the simulation in more detail, an example software product with multiple development branches or code branches will be discussed with respect to FIG. 5 to provide additional background information for the simulation description.

FIG. 5 is a diagram illustrating activities on development branches of an example software product according to one embodiment. Some software products, such as the one represented in FIG. 5, are developed using a trunk branch as well as other branches. Branches are grouped by their branch level—the distance of the branch to the trunk branch. L1-branches integrate directly into the trunk branch, while code changed in an L2-branch is first integrated into an L1-branch before reaching the trunk branch. The example shown in FIG. 5 includes an L1 branch 502(1) (“Branch B1”) and an L2 branch 502(2) (“Branch B2”), which are collectively referred to as branches 502. A trunk branch (not shown in FIG. 5) would be positioned below the branch 502(1).

Typically, different branch sub-trees will contribute code changes, such as code changes 504, from different application areas (e.g., networking, kernel, etc.). Engineers submit their code changes 504 into development branches 502 (i.e., leaf nodes in the branching tree), which allows them to work in isolation from other teams while the feature is being implemented and stabilized. The trunk branch contains the code base that will eventually ship to the customer. To get the code changes 504 integrated into the trunk branch, code changes are pushed down the tree, which includes progressively merging the code change with all code changes implemented in parallel in the same sub-tree, as represented by merge operations 514.

All activities performed on a branch (e.g., changes 504, sync operations 512, builds 506, testing 508, and merges 514) can be grouped around builds in branch activity phases 520. The build 506 is the event in each branch activity phase that involves a compilation of the code base. Each build 506 automatically triggers the execution of the tests 508 associated with the branch 502. The result of each build 506 and the corresponding test executions 508 determine if the current code base can be merged to the lower level branch (e.g., from branch 502(2) into branch 502(1)). A successful test execution 508 in FIG. 5 is represented by a checkmark, and a failed test execution is represented by a minus sign. To determine whether the code base is causing issues when merged with changes that already reached the trunk branch since the last synchronization, the code base of the current branch is synced 512 with the main code base from the trunk branch just before the build 508. All code changes merged 514 or directly applied to a branch after the last build 508 will be part of the next branch activity phase.

If a build 508 fails, the code base present in this branch is incompatible with the current code base in the trunk branch and is revised. The branch will be blocked for merge events 514 until the problem is resolved and a build 506 and test execution 508 succeeds. Thus, each build phase consists of the following five stages:

1. Code changes 504 are applied. This can be direct edits by engineers (typically on development branches) or merged code changes from higher level branches. Typically, builds 506 accumulate multiple changes 504.

2. A sync event 512 synchronizes the branch code base with the main code base from the trunk branch.

3. The build 506 compiles the code base into binaries.

4. The branch specific testing 508 on the created binaries is executed.

5. If compilation and testing succeed, the code base is merged 514 down the branch tree (changes are included in the next build on the next lower level branch). If the build 506 fails, a failure is reported to the responsible engineer and the code base is not merged 514.

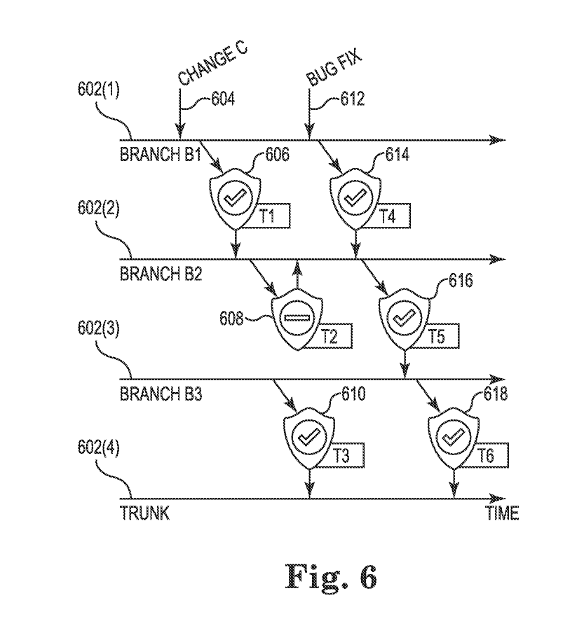

Assuming a trunk branch, the integration path of a code change is a sequence of branches and timestamps the corresponding code change was applied to before the code change was merged into the trunk branch. For projects using a single development branch, the integration path of a code change is a single entry identifying the name of the single branch and the timestamp. For projects using multiple code branches, the integration path usually contains multiple entries. For example, consider the example shown in FIG. 6.

FIG. 6 is a diagram illustrating a potential path of a code bug between four code branches 602(1)-602(4) (collectively referred to as code branches 602), with branch 602(1) representing the highest level branch, and branch 602(4) representing the lowest level or trunk branch. Each of the code branches 602 is represented by a horizontal line that represents time. Six sets of tests 606, 608, 610, 614, 616, and 618 are shown in FIG. 6. Tests 606, 610, 614, 616, and 618 represent successful tests (indicated by a check mark), and test 608 represents a failed test (indicated by a minus sign). As shown in FIG. 6, a change C is made to branch 602(1), as represented by arrow 604. The integration path of change C lists the branches 602(1)-602(4), including the timestamps of the corresponding successful merge operation that applied change C to the code base in each branch 602. For each change originally applied to the version control system, their corresponding integration paths are computed, tracing code changes through the version control system.

In one embodiment, the following two assumptions are made with respect to code issues and test cases detecting those code issues:

1. A combination of test case and execution context, which detected and reported a defect at time tᵢ will also detect and report the same defect at any time tₖ if and only if tₖ≧tᵢ and if tₖ is executed on an integration path of the defect. This assumption disregards that (even though unlikely) the code issue might have be suppressed but not fixed by other code changes applied to the code base.

2. The code issue can be replicated by re-running the test in the corresponding execution context.

The integration path of code changes is assumed to correspond to the propagation path of undetected defects, and can be used to estimate which test execution would have re-captured an escaped defect. In the example shown in FIG. 6, the branch 602(1) code including change C successfully passes test 606 and the code is merged with branch 602(2), but a defect in change C is caught by test 608 and the code does not progress past branch 602(2). A bug fix is created as represented by arrow 612, and the bug fix is verified by tests 614, 616, and 618. If test 608 is skipped, the defect is assumed to be immediately merged into branch 602(3). It is assumed that the defect is caught by test 618 as it runs the same tests as test 608. In this scenario, the bug fix would be applied in branch 602(1) after running test 618 and it would be assumed that the cost of fixing the defect is now higher than its original cost.

While the original association between defect and test execution is stored in the test execution framework database, simulator 308 returns a modified version of the original association reflecting simulation results. For each test that is executed during simulation, all original code issues detected during test execution are kept. Additionally, all escaped defects are assigned to the test execution that would have been caught given the heuristics above. As a result, the number of defects associated with a test execution equals the number of defects during the actual execution of the test, plus an additional set of escaped defects.

System 200 according to one embodiment optimizes testing processes without sacrificing product quality. This implies that all escaped defects are eventually caught, before releasing the product to customers. To satisfy this condition, system 200 ensures that all originally executed combinations of tests and execution contexts for all code changes applied to the code base are executed at least once. To ensure this happens, two separate criteria are used, depending on the development process:

1. For single branch development processes, each test is executed at least every third day. Since all code changes are applied to the same branch, re-execution of each test for each execution context periodically ensures that each code change has to go through the same verification procedures as performed originally.

2. For multi-branch development processes, a combination of test and execution context is executed on the branch closest to the trunk on which the test had been executed originally.

Thus, system 200 according to one embodiment skips test executions if the criteria described above allow a test to be skipped. Otherwise, a decision by system 200 to skip a test in a given execution context will be ignored and the test will be executed.

As the underlying cost model depends on risk factors extracted from historic data, these risk factors will be unknown and unreliable in the early stages of the simulation process, in which no historic data is known. To compensate, each test and execution context combination went through a training phase of 50 executions before the simulator 308 allowed disabling of the corresponding test in the given execution context.

Simulation Evaluation

An evaluation of the simulation identified the number of test executions that were skipped. To retrieve this number, the number of originally recorded test executions was counted, and the number of test executions that would have been executed during simulation was subtracted. The number of skipped test executions and their summed execution duration determines how much machine cost C_{machine} has been saved.

Test failures involve human effort for inspection in order to decide what action to take. Skipping test cases that would have caused unnecessary test inspections (false alarms) is an improvement. Relating these suppressed false alarms with the corresponding cost factor for test failure inspections (C_{inspect}), identifies the relative improvement with respect to test inspection time and the associated development cost improvements.

The effects of system 200 were evaluated on three major Microsoft products during a specific time frame of the development: Windows, Office, and Dynamics. For Windows, the results show that system 200 would have skipped 40.6% of all test executions across all branches. Considering the runtime of these tests and relating it to the total runtime of all executed tests, system 200 would have saved 40.3% of the total test execution time. Multiplying the test time improvement with the cost factor for test execution (C_{machine}), yields a cost improvement of over $1.6 million. Note that the test time cost improvement figures consider the time of not executing the skipped tests. It does not include potential cost improvements due to skipping test setups, test teardowns, removing entire dedicated test machines from a branch, etc. Thus, the test time cost improvement can be seen as a lower bound of the actual cost improvement.

For Dynamics, the average test execution reduction rate for was above 50%. This means that system 200 would have prevented more than half of the originally executed test executions and saved 47% of test execution time. In theory, code could have been moved nearly 50% faster into the trunk branch. Although the test execution and test time reduction rate exceeds the values achieved for Windows, the test machine cost improvements that correlated with the reduced test time are two orders of magnitude lower than for Windows. This is due to the fact that tests executed for Dynamics terminate faster than Windows tests. Thus, the reduction rate translates into less computational time.

The same is true for the Office tests, which also execute faster and therefore the savings on reduction of test execution time are lower than for Windows. The results show that system 200 would have skipped 34.9% of all performed test executions and saved 40.1% of the total test execution time.

System 200 specifically targets unnecessary test inspections caused by test failures caused by other reasons than code defects (false test alarms). Suppressing such test failures implies reduction of unnecessary test result inspections, which again translates into cost savings. For Windows and Dynamics, the reduction rate is about 33%. Thus, one third of originally carried out test result inspections were unnecessary. For Office, system 200 would be able to reduce about 21% of all false positives. For Windows, a cost saving of $61 k has been estimated. For Office, a cost saving of $104 k has been estimated. For Dynamics, a cost saving of $2.3 million has been estimated. The reason for the difference is the different absolute number of test failures suppressed.

While the number of saved task executions and the decrease in the number of test inspections determines a positive cost savings, the number of defects that temporarily escaped testing increases development costs. In the Windows simulation, 0.2% of all defects escaped at least one test execution. 71% of these escaped defects escaped one branch and were found in the corresponding next merge branch. 21% of escaped Windows defects escaped two branches and 8% escaped 3 branches. None of the defects escaped into the trunk branch. On Dynamics, system 200 would have elapsed 13.4% of all defects, a much higher escape rate as for Windows. The vast majority (97%) of these escaped Dynamics defects were caught on the direct consecutive merge branch. The remaining 3% escaped two branch levels. For both Windows and Dynamics, the extra costs caused by escaped bugs are orders of magnitude lower than the highest cost savings achieved by removed test executions and inspections.

For Office, the results are a bit different. Whereby the percentage of bugs that escaped is 8.7%, which is comparable to Dynamics, the costs are $75 k higher in relation to the cost savings. This is due to an additional cost of manual testing work that was added as a penalty for Office in case the bugs were not found within 10 days. The rationale behind this lies in the way the Office test and development is performed. Nevertheless, approximately 40% of bugs escaped would have been found already in the next scheduled build and test.

Looking at the overall cost balance, system 200 would provide cost savings for all three evaluation subjects. For Windows, a total cost saving of $1.6 million has been estimated. For Dynamics, a total cost saving of approximately $2.0 million has been estimated. For Office, a cost saving of approximately $100 k has been estimated.

Variable Performance over Time

In one embodiment, system 200 undergoes an initial training phase where the system 200 observes the current testing process and learns and estimates risk factors before applying any test selection. Once the system 200 starts skipping test executions, the ratio of removed tests converges to a stable state. There exist multiple spikes in which the relative number of reduced test cases drops again. The reason for the spikes and unstable reduction measures is natural fluctuations in code quality. The quality of submitted code changes is not constant. A drop in overall code quality causes more test failures and thus directly impacts risk factors. System 200 reacts dynamically to these changes by causing previously skipped tests to be re-enabled.

Code Velocity

Reducing the number of executions and consequently the overall test time may have positive effects on code velocity. Executing fewer tests implies that code changes have to spend less time in verification, and verification results are more quickly available and changes can be integrated faster, freeing up engineering time that may have been spent evaluating false positives. However, the immediate impact on code velocity is hard to measure. Code velocity is determined by many different aspects, including human behavior, which is not possible to simulate. Thus, it is hard to predict how system 200 would affect actual development speed. It might well be that the bottleneck of current development processes is not only testing. Nevertheless, the number of executed tests represents a lower bound to code velocity, as the consecutive time to pass all tests is the minimal time to integrate code changes. By lowering the number of executed tests, system 200 lowers the lower bound for code velocity.

Developer Satisfaction

A difficult to measure factor of every development process is developer satisfaction. Reducing the time for testing and the number of test inspections is likely to increase developer satisfaction. It should help to increase the confidence in test results and decisions based on testing. Increasing the speed of the development process will itself also impact the developer experience. The ability to merge, integrate, and share code changes faster can reduce the number of merge conflicts and is likely to support collaboration.

### CONCLUSION

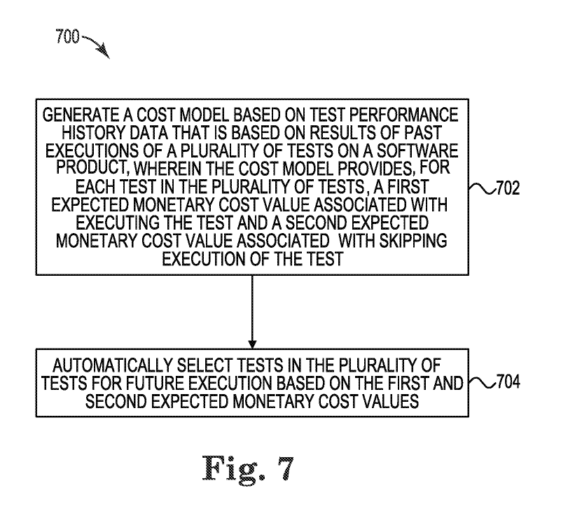

FIG. 7 is a flow diagram illustrating a method 700 of automatically selecting tests for execution on a software product according to one embodiment. In one embodiment, system 200 (FIG. 2) is configured to perform method 700. At 702 in method 700, a cost model is generated based on test performance history data that is based on results of past executions of a plurality of tests on a software product, wherein the cost model provides, for each test in the plurality of tests, a first expected monetary cost value associated with executing the test and a second expected monetary cost value associated with skipping execution of the test. At 704, tests in the plurality of tests are automatically selected for future execution based on the first and second expected monetary cost values.

In one embodiment of method 700, the generating a cost model at 702, and the automatically selecting tests at 704 are performed by at least one processor. The test performance history data in method 700 according to one embodiment includes execution context information for each execution of one of the tests in the plurality of tests. The execution context information includes at least one of a build type of software code being tested, an architecture type of execution hardware that is being simulated, language of the software code being tested, and an identification of a code branch on which test execution was performed. In one embodiment, the test performance history data further includes, for each execution of one of the tests in the plurality of tests, a unique identifier, a duration of test execution, and test results information. The test results information identifies successfully passed tests, true positive test failures indicating code-related defects, and false positive test failures indicating non-code-related defects.

One embodiment of method 700 further includes automatically determining whether a test failure is a true positive test failure or a false positive test failure based on at least one bug report. The first expected monetary cost in method 700 according to one embodiment includes an estimated monetary cost of infrastructure to execute a test. In one embodiment, the first expected monetary cost further includes an estimated monetary cost for human inspection of a false positive test failure. The estimated monetary cost for human inspection is multiplied by a probability value that represents a probability of detecting a false positive test failure. In one embodiment, the second expected monetary cost value includes an estimated monetary cost of an escaped code defect. The estimated monetary cost of the escaped code defect is multiplied by a probability value that represents a probability of detecting a true positive test failure.

One embodiment of method 700 further includes, for each past execution of each test in the plurality of tests, recording in the test performance history data a corresponding execution context; and for each of the execution contexts of each of the tests in the plurality of tests, determining a first test-specific and context-specific expected monetary cost value associated with test execution, and a second test-specific and context-specific expected monetary cost value associated with skipping test execution. In one form of this embodiment, tests in the plurality of tests are automatically selected for future execution based on the first and second test-specific and context-specific expected monetary cost values.

Another embodiment is directed to a computer-readable storage medium storing computer-executable instructions that when executed by at least one processor cause the at least one processor to perform a method. The method includes generating a cost model based on test performance history data that is based on results of past executions of a plurality of tests on a software product, wherein the cost model provides, for each test in the plurality of tests, a first expected monetary cost value associated with executing the test and a second expected monetary cost value associated with skipping execution of the test. A first test in the plurality of tests is selected for future execution when the second expected monetary cost value for the first test exceeds the first expected monetary cost value for the first test. A future scheduled execution of the first test is skipped when the first expected monetary cost value for the first test exceeds the second expected monetary cost value for the first test.

Yet another embodiment is directed to a code test selection system. The system includes a test performance history module configured to provide test performance history data based on results of past executions of a plurality of tests on a software product for a plurality of execution contexts. The system includes a cost model module configured to identify for each test in the plurality of tests and for each of the execution contexts, a first expected monetary cost value associated with executing the test in that execution context and a second expected monetary cost value associated with skipping execution of the test. The system includes a test selection module configured to automatically select tests in the plurality of tests for future execution based on the first and second expected monetary cost values.

Embodiments disclosed herein provide a cost based test selection system 200 to improve development processes. The system 200 is a dynamic, self-adaptive test selection system, which does not sacrifice product quality, and which uses historical test data that is already collected by most test frameworks. The system 200 automatically skips test executions when the expected cost of running a test exceeds the expected cost of not running it. In one embodiment, system 200 evaluates system and integration test effectiveness based on execution contexts, such as branching structures and architectures.

System 200 was verified through simulating its impact on the Microsoft Windows, Office, and Dynamics developments. System 200 would have reduced the number of test executions by up to 50% cutting down test time by up to 47%. At the same time, product quality was not sacrificed as the process ensures that all tests are run at least once on all code changes. Removing tests would result in between 0.2% and 13% of defects being caught later in the development process, thus increasing the cost of fixing those defects. Nevertheless, simulation shows that system 200 produced an overall cost reduction of up to $2 million per development year, per product. Through reducing the overall test time, system 200 would also have other impacts on the product development process, such as increasing code velocity and productivity. These improvements are hard to quantify but are likely to increase the cost savings estimated in this disclosure.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A method of automatically selecting tests for execution on a software product, the method comprising:
generating a cost model based on test performance history data that is based on results of past executions of a plurality of tests on the software product, wherein the cost model provides, for each test in the plurality of tests, a first expected monetary cost value associated with executing the test and a second expected monetary cost value associated with skipping execution of the test;
automatically selecting tests in the plurality of tests for future execution based on the first and second expected monetary cost values; and
wherein the generating a cost model and automatically selecting tests are performed by at least one processor.

2. The method of claim 1, wherein the test performance history data includes execution context information for each execution of one of the tests in the plurality of tests.

3. The method of claim 2, wherein the execution context information includes at least one of a build type of software code being tested, an architecture type of execution hardware that is being simulated, language of the software code being tested, and an identification of a code branch on which test execution was performed.

4. The method of claim 2, wherein the test performance history data further includes, for each execution of one of the tests in the plurality of tests, a unique identifier, a duration of test execution, and test results information.

5. The method of claim 4, wherein the test results information identifies successfully passed tests, true positive test failures indicating code-related defects, and false positive test failures indicating non-code-related defects.

6. The method of claim 5, and further comprising:
automatically determining whether a test failure is a true positive test failure or a false positive test failure based on at least one bug report.

7. The method of claim 1, wherein the first expected monetary cost includes an estimated monetary cost of infrastructure to execute a test.

8. The method of claim 7, wherein the first expected monetary cost further includes an estimated monetary cost for human inspection of a false positive test failure.

9. The method of claim 8, wherein the estimated monetary cost for human inspection is multiplied by a probability value that represents a probability of detecting a false positive test failure.

10. The method of claim 1, wherein the second expected monetary cost value includes an estimated monetary cost of an escaped code defect.

11. The method of claim 10, wherein the estimated monetary cost of the escaped code defect is multiplied by a probability value that represents a probability of detecting a true positive test failure.

12. The method of claim 1, and further comprising:
for each past execution of each test in the plurality of tests, recording in the test performance history data a corresponding execution context; and
for each of the execution contexts of each of the tests in the plurality of tests, determining a first test-specific and context-specific expected monetary cost value associated with test execution, and a second test-specific and context-specific expected monetary cost value associated with skipping test execution.

13. The method of claim 12, and further comprising:
automatically selecting tests in the plurality of tests for future execution based on the first and second test-specific and context-specific expected monetary cost values.

14. A computer-readable storage medium storing computer-executable instructions that when executed by at least one processor cause the at least one processor to perform a method, comprising:
generating a cost model based on test performance history data that is based on results of past executions of a plurality of tests on a software product, wherein the cost model provides, for each test in the plurality of tests, a first expected monetary cost value associated with executing the test and a second expected monetary cost value associated with skipping execution of the test;
selecting a first test in the plurality of tests for future execution when the second expected monetary cost value for the first test exceeds the first expected monetary cost value for the first test; and
skipping a future scheduled execution of the first test when the first expected monetary cost value for the first test exceeds the second expected monetary cost value for the first test.

15. The computer-readable storage medium of claim 14, wherein the test performance history data includes execution context information for each execution of one of the tests in the plurality of tests.

16. The computer-readable storage medium of claim 15, wherein the execution context information includes at least one of a build type of software code being tested, an architecture type of execution hardware that is being simulated, language of the software code being tested, and an identification of a code branch on which test execution was performed.

17. The computer-readable storage medium of claim 15, wherein the test performance history data further includes test results information that identifies successfully passed tests, true positive test failures indicating code-related defects, and false positive test failures indicating non-code-related defects.

18. The computer-readable storage medium of claim 14, wherein the first expected monetary cost includes an estimated monetary cost of infrastructure to execute a test, and an estimated monetary cost for human inspection of a false positive test failure.

19. The computer-readable storage medium of claim 14, wherein the second expected monetary cost value includes an estimated monetary cost of an escaped code defect.

20. A code test selection system, comprising:
a test performance history module configured to provide test performance history data based on results of past executions of a plurality of tests on a software product for a plurality of execution contexts;
a cost model module configured to identify for each test in the plurality of tests and for each of the execution contexts, a first expected monetary cost value associated with executing the test in that execution context and a second expected monetary cost value associated with skipping execution of the test; and
a test selection module configured to automatically select tests in the plurality of tests for future execution based on the first and second expected monetary cost values.
